(19) United States
(12) Patent Application Publication
(10) Pub. No.: US 2008/0095630 A1
(43) Pub. Date: Apr. 24, 2008

(54) BLADE WHEEL FOR A SEWAGE PUMP

(76) Inventor: Robert M. Keener, Ashland, OH (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/550,884

(22) Filed: Oct. 19, 2006

(51) Int. Cl. B64C 11/00

(52) U.S. Cl. 416/182

(57) ABSTRACT

A blade wheel for a sewage pump has a top plate and multiple curved blades radially attached to the top late. The top plate is adapted to perpendicularly combine with a main shaft of a motor and has a shaft hole with a slit at a center on the top plate. The multiple curved blades are integrally formed on a bottom face of the top plate and have at least three different heights. By attaching the curved blades in different heights, the precipitation can be sufficiently guided into a sewage pump for chopping and flung out of sewage tank.

### BACKGROUND OF THE INVENTION

1. Field of the Invention

The present invention relates to a blade wheel for a sewage pump, and more particularly to a blade wheel that enables to guide precipitation in the sewage into a sewage pump for chopping and to efficiently discharge the sewage.

2. Description of Related Art

A conventional sewage pump in accordance with the prior art is connected with a motor by a main shaft and has a grinding wheel, a lower blade wheel and a upper blade wheel sleeving on the main shaft in sequence from inside to outside. When the motor actuates, the grinding wheel, the lower blade wheel and the upper blade wheel are driven to rotate by the main shaft. Moreover, rotation of the grinding wheel, the lower blade wheel and the upper blade wheel generate current to guide the precipitation into a lower base. When the precipitation passes an entrance on the lower base, the grinding wheel grinds the precipitation. When the grinded precipitation is guided from a lower blade chamber to an upper blade chamber, the grinded precipitation is flung out of the lower base by a centrifugal force provided by the upper blade wheel.

The structure of the upper blade wheel 1 in the conventional sewage pump is shown in FIGS. 1 and 2, it is composed of a top plate 11 and multiple curved blades 12 radially and integrally mounted on the top plate 11 with equal intervals. Because the multiple curved blades 12 are the same in height, the upper blade wheel has insufficient guiding efficiency. When the curved blades 12 can not catch the precipitation sufficiently, the grinded precipitation can not be completely flung out of the lower base by the centrifugal force so that the sewage pump has poor efficiency in use.

According to above description, the conventional sewage pump still has some drawbacks in use.

### SUMMARY OF THE INVENTION

A main objective of the present invention is to provide a blade wheel that comprises at least three types of curved blades in different heights radially arranged to improve a guiding efficiency to precipitation in the sewage so that the precipitation can be flung out efficiently by the centrifugal force when the blade wheel is in rotation.

To achieve the foregoing objective, the blade wheel for a sewage pump comprises:

A blade wheel for a sewage pump, the blade wheel comprising:

a top plate being a round board; and

multiple curved blades radially and integrally arranged on the top plate, wherein the multiple curved blades have different heights to improve guiding efficiency of the blade wheel.

By having the curved blades in different heights, the blade wheel has excellent guiding efficiency to guide and fling the precipitation outside.

Further benefits and advantages of the present invention will become apparent after a careful reading of the detailed description with appropriate reference to the accompanying drawings.

### BRIEF DESCRIPTION OF THE DRAWINGS

FIG. 1 is a perspective top view of an upper blade wheel in accordance with the prior art;

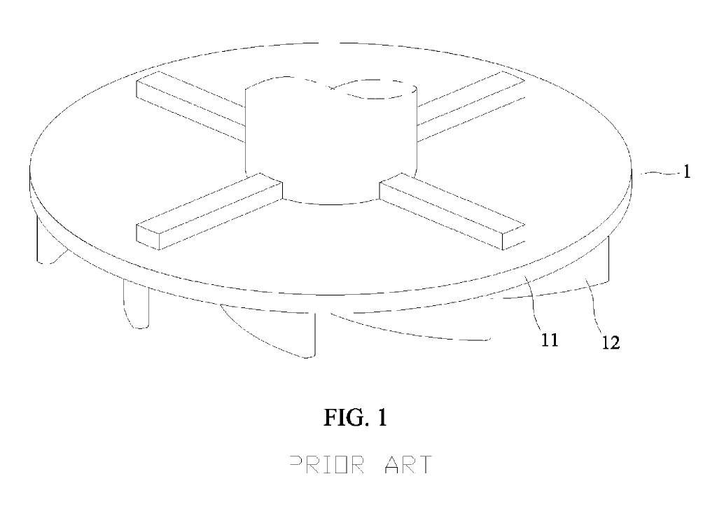

FIG. 2 is a perspective bottom view of the upper blade wheel in FIG. 1;

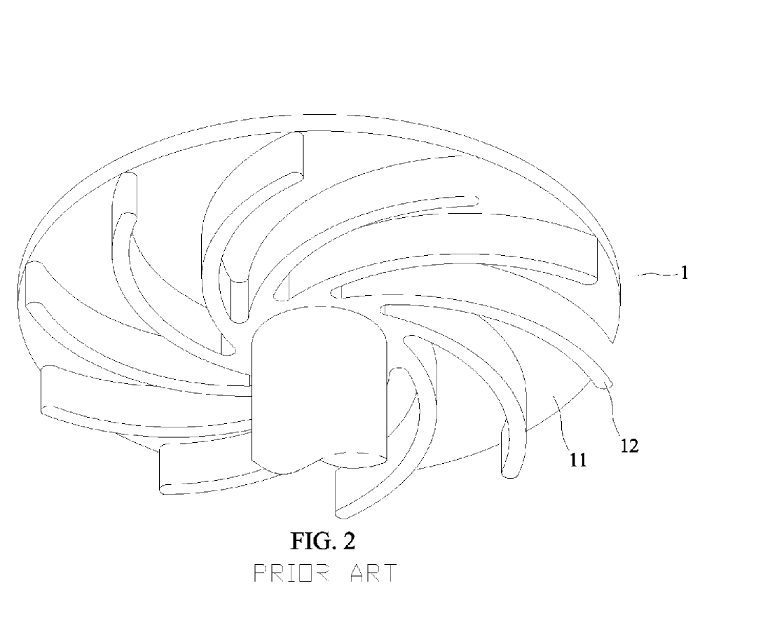

FIG. 3 is a schematic cross-sectional view of a sewage pump located inside a sewage tank;

FIG. 4 is a cross-sectional view of a blade wheel in accordance with the present invention, wherein the blade wheel is mounted to a lower base inside the sewage pump;

FIG. 5 is a perspective view of the sewage pump;

FIG. 6 is a perspective top view of the blade wheel in the sewage pump;

FIG. 7 is a perspective bottom view of the blade wheel in the sewage pump; and

FIG. 8 is a bottom view of the blade wheel in the sewage pump.

### DETAILED DESCRIPTION OF THE PREFERRED EMBODIMENT

A blade wheel for a sewage pump in accordance with the present invention comprises a top plate and multiple curved blades radially attached to the top late. The top plate is adapted to perpendicularly combine with a main shaft of a motor and has a shaft hole with a slit at a center on the top plate. The multiple curved blades are integrally formed on a bottom face of the top plate and have at least three different heights. By attaching the curved blades in different heights, the precipitation can be sufficiently guided into a sewage pump for chopping and flung out of a sewage tank 4.

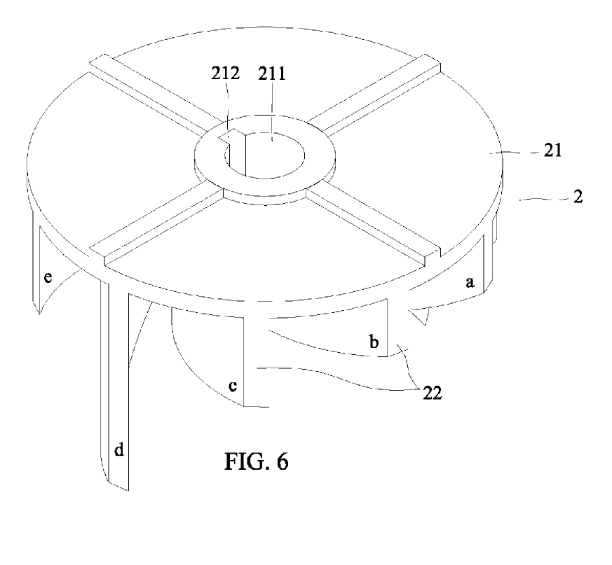

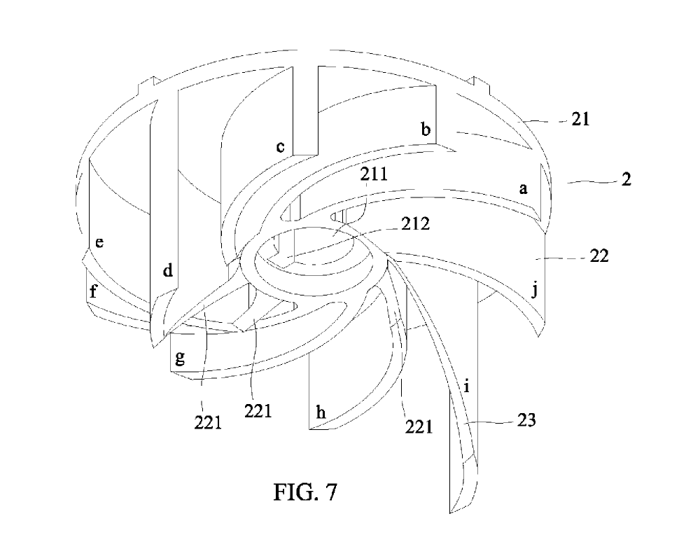

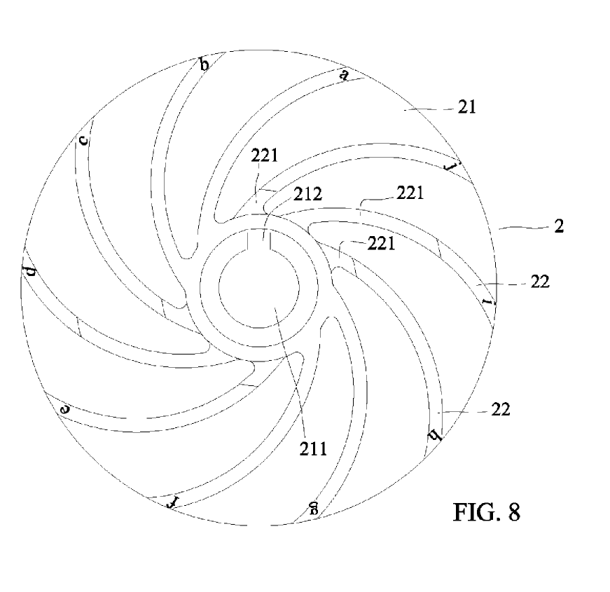

With reference to FIGS. 6, 7 and 8, a preferred embodiment of the blade wheel 2 for a sewage pump 3 comprises a top plate 21 and multiple curved blades 22 radially formed on the top plate 21.

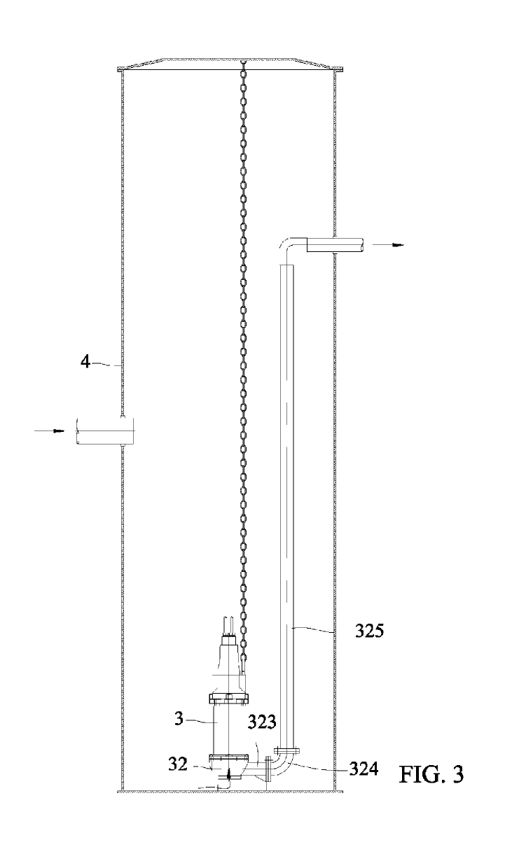

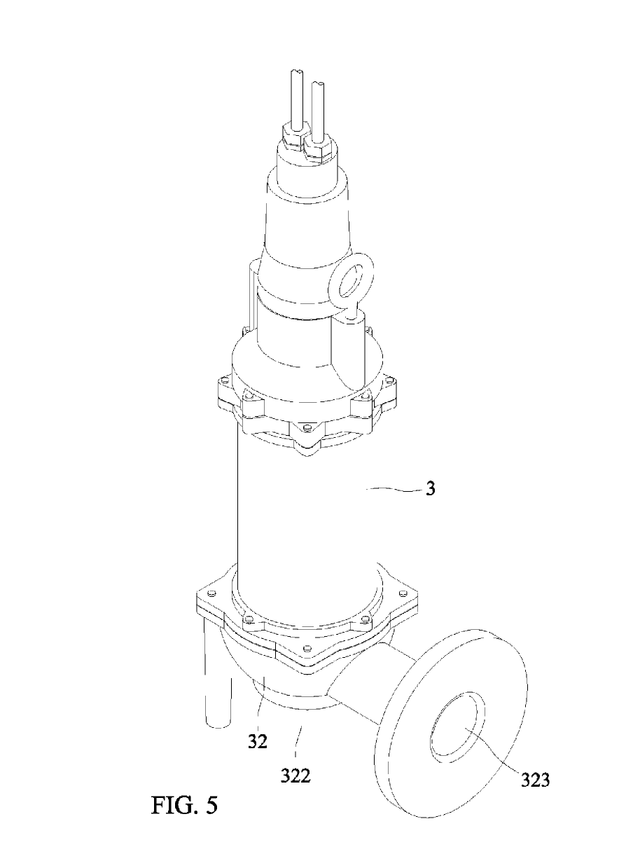

The top plate 21 is a round board with a center and adapted to perpendicularly combine with a main shaft 311 on a motor 31 as shown in FIGS. 3 to 5. A shaft hole 211 with a slit 212 is defined at the center of the top plate 21.

The multiple curved blades 22 are integrally formed on a bottom face of the top plate 21 and have three different heights, wherein blades 22 indicated as a, b, f, and g are the shortest, blades 22 indicated as c, e, h, and j are medium, and blades 22 indicated as d and l are the highest. Moreover, the blades c, e, h, and j and blades d and i each have a slope 23 formed in unidirectional clockwise formation, i.e. the shortest blades has no slope. Preferably, the blades 22 are arranged in a certain sequence to make the edge line of the blade wheel as a smooth curved and thus create vortex to improve the guiding efficiency created by the arranged blades in different heights.

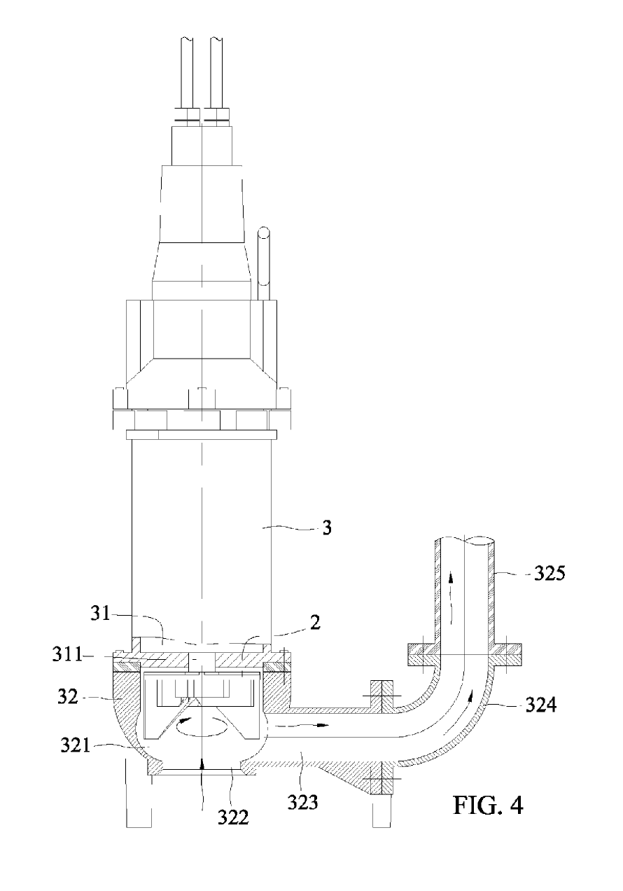

The blade wheel 2 is adapted to mount inside a blade chamber 321 at a lower base 32 of the sewage pump 3 as shown in FIG. 4. The shaft hole 211 on the top plate 21 perpendicularly engages the main shaft 311 on the motor 31. Wherein, the lower base 32 has a precipitation inlet 322 at a bottom and an outlet defined at sidewall to connect with a switch connector 324 and a conducting pipe 325.

When the motor 31 in the sewage pump 3 actuates, the main shaft 311 drives the blade wheel 2 to rotate clockwise to generate vortex and thus to sock precipitation deposited in bottom of the sewage tank 4 into the blade chamber 321 of the lower base 32. The slopes 23 make edges of the blades 22 sharp to chop the precipitation. Then, the broken precipitation is flung out of the blade chamber 321 by centrifugal force created by rotation of the blades 22 and by high water pressure created by turbulence during rotation, wherein the turbulence is particularly generated by the curved blades 22 with different heights. The broken precipitation is then conducted out of the sewage tank 4 via the switch connector 324 and the conducting pipe 325.

According to above description, the blade wheel for a sewage pump in the present invention has the following advantages:

1. The blade wheel is substantially composed of at least three curved blades 22 in different heights and arranged in a radial arrangement so that the blade wheel 2 has sufficient guiding and chopping efficiency. After chopping, the precipitation is flung out of the lower base 32 of the sewage pump 3 by centrifugal force created by rotation of the blade wheel 2.

2. The blade wheel efficiently improves in chopping and flinging capabilities by modifying structure simply so that manufacturers can manufacture the blade wheel rapidly and efficiently and reduce cost to enhance utility thereof.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A blade wheel for a sewage pump, the blade wheel comprising:
a top plate being a round board; and
multiple curved blades radially and integrally arranged on the top plate, wherein the multiple curved blades have different heights to improve guiding efficiency of the blade wheel.

2. The blade wheel as claimed in claim 1, wherein the multiple curved blades have includes highest blades, medium blades and shortest blades arranged in sequence and circulation of one highest blade, one medium blade and two shortest blades.

3. The blade wheel as claimed in claim 2, wherein the medium blades and the highest blades each have a distal end and slop formed at the distal end to perform a sharp edge.
